(19) United States
(12) Patent Application Publication
(10) Pub. No.: US 2013/0179284 A1
(43) Pub. Date: Jul. 11, 2013

(54) Social Price

(71) Applicant: David Sean Strager, Hermosa Beach, CA (US)

(72) Inventor: David Sean Strager, Hermosa Beach, CA (US)

(21) Appl. No.: 13/344,476

(22) Filed: Jan. 5, 2012

(51) Int. Cl. G06Q 30/00

(52) U.S. Cl. 705/26.1

(57) ABSTRACT

The present invention provides a system and method, implemented in part on an internet sale's entity's website for enabling prospective customers to control the price of a given product through customers' referrals in their social networking systems. In other words, the price of a given product is driven down by popularity. That means, the more an item is shared and talked about the lower the price. The popularity of a given product may be determined based on the number of referrals. Each unique referral that comes from customers using the system will lower the price by a given integer which may be one penny or more. Once the product's price reaches a predetermined bottom limit or timer is up, it will become the daily deal for a period of time.

### BACKGROUND OF THE INVENTION

1. Field of the Invention

The present invention relates to a system and method utilizing social networking systems for product referrals, and more particularly to system and method implemented on the sales entity's website which gives potential customers the unique ability to control the price of a given product by referring the given product in their social networking systems.

2. Description of Related Art

In recent years, the computer and internet have become an important part of everyday life. It has become common for merchants to set up websites for marketing and selling commercial products online. In addition, online merchants typically offer more varieties and fashion designs which may not be easily found in regular stores. As a result, instead of driving for a long distance to shop in a store, people have started to shop online. This trend is especially growing fast among generations who also spend a lot of time on the internet to talk with friends using emails and/or share life experience with friends in social websites. However, one common problem encountered by online merchants is that there are too many online merchants and the online merchant is not able to market goods efficiently on internet. Although business typically has many advertising options when attempting to generate new customers, the easiest, least expensive, and most efficient advertising option come from word-of-mouth referrals from other customers and/or prospective customers. Consequently, customers' and prospective customers' social networks have become a valuable assets to online merchants for marketing and selling product. Thus, it is desirable to have a system and method to attract prospective customers to the online merchant website and to motivate prospective customers and customers to make word-of-mouth referrals for the online merchants.

Currently, there is no system and method that gives prospective customers and customers the ability to control the price of a given product using their social networks. In particular, there is no system and method that utilizes the quantity of referrals to control the final price of a given product.

### SUMMARY OF THE INVENTION

The present invention provides a system and method, implemented in part on an internet sales entity's (referred as “vendor” hereinafter) web site for enabling prospective customers and customers (both prospective customers and customers are referred as “customers” hereinafter) to control the price of a given product through customers' referrals in their social networking systems. In other words, the price of a given product is driven down by popularity. That means, the more an item is shared and talked about the lower the price. The popularity of a given product may be determined based on the number of referrals. Hence, the final reduced price is also called “social price” in this application.

The method utilizes the quantity of referrals to control the final price of a given product. Each unique referral that comes from customers using the system will lower the price by a given integer which may be one penny or more. For example, originally, product X costs 10.99 dollars. Each unique referral is set to be worth one penny. As a result, once this given product gets 1,099 unique referrals the final price will then become 0.00 dollars. Alternatively, the system and method may set a bottom limit for the price, for example, 50% discount as the bottom limit. When the price of a give product is reduced to 50% of the original price, the system no longer receives more referrals, the price is finalized and post on the website.

The system and method for enabling customer to control the price of a given product comprises a vendor website allowing customers to participate the social price program; a referral system allowing customers to make referral; and a price system wherein each unique referral that comes from customers using the system will lower the price by a given drop point.

The referral system comprises social tools that can link a customer to social websites or send friends email by a simple click; a product specific referral link that can link a customer's friend in a social website to the vendor website as a visitor; a referral counter which tracks referrals of visitors to the website; and a database which stores visitors' information.

The price system comprises a database to store product prices; a pricing tool to convert each unique referral to a drop point according to a preset formula for each given product and subtract the drop point from the original price, and outputs the new price for display; and a price progress bar for displaying price dropping progress.

The system and method further comprises a timer which is set to counting down against a preset time period for customers to share the product and make referrals within the time period in order to effect the price change.

The system and method may further comprise a registration system which creates an account for a customer in response to a submission to the registration system by the customer, assigns an identifier to the customer, and stores the customer's information in a database.

The system and method may or may not require customers to register in order to benefit from the social price.

The website page will provide the product-specific referral link (referred as “product link” hereinafter) and social tools in a form of smart graphic icon button. Social tools are a conduit to get the referral traffic. The website also shows a timer to show how much time left for customers to make product referrals in order to change product price. It also contains a price progress bar to indicate the price dropping progress in real time. Each unique referral that comes from customers using the system will lower the price by a given integer which may be one penny or more. Once the product's price reaches a predetermined bottom limit or timer is up, it will become the daily deal for a period of time.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a high-level architectural drawing illustrating the primary components of a system that operates in accordance with the present invention.

FIG. 2 is a screen display of the vendor's website showing a product specific referral link that can be copied and pasted, social tool graphic icons, as well as a price progress bar showing how the price is being affected.

FIG. 3 is a screen display illustrating the portal asking user's approval to post the product link on their social network and an example of the customer's social website page showing link has been posted on Tweeter.

FIG. 4 is a flow diagram illustrating a given product referral sequence and a given product price dropping process in response to the product referral.

### DESCRIPTION OF THE PREFERRED EMBODIMENT

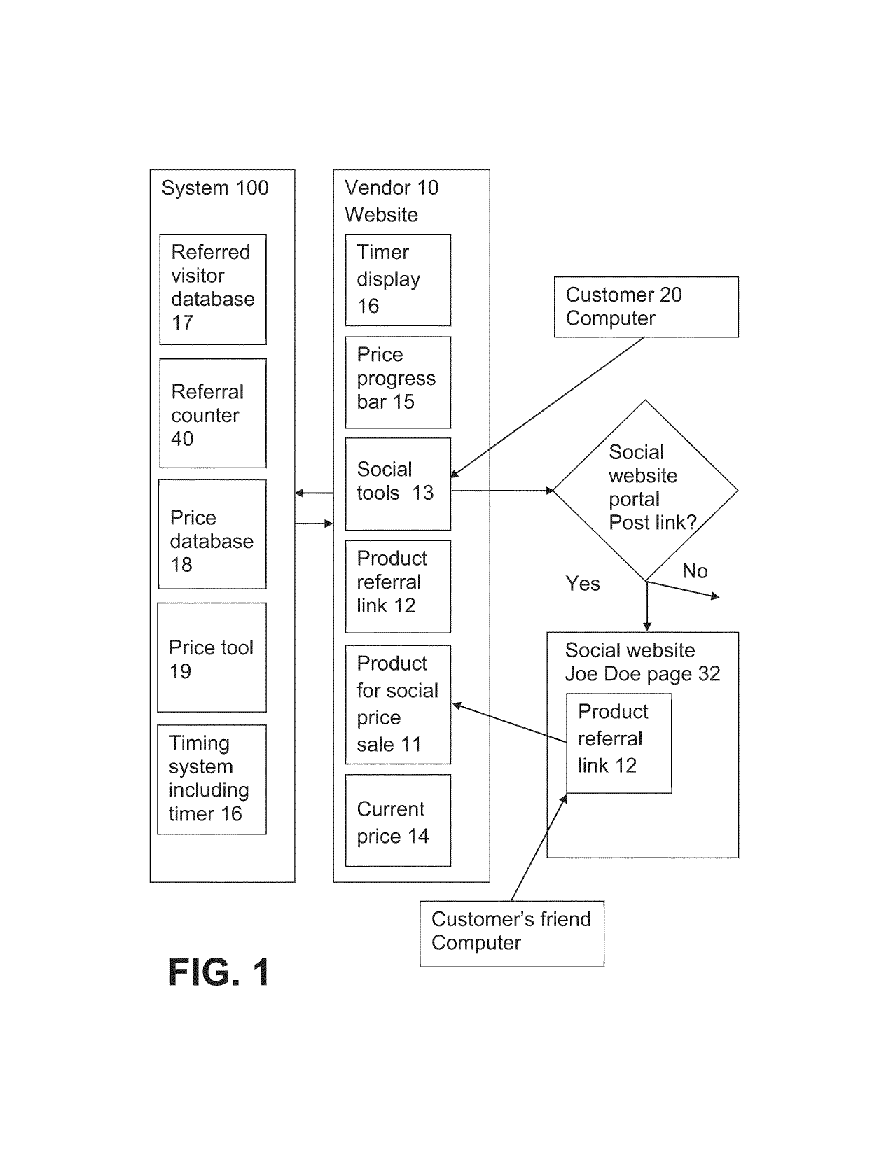

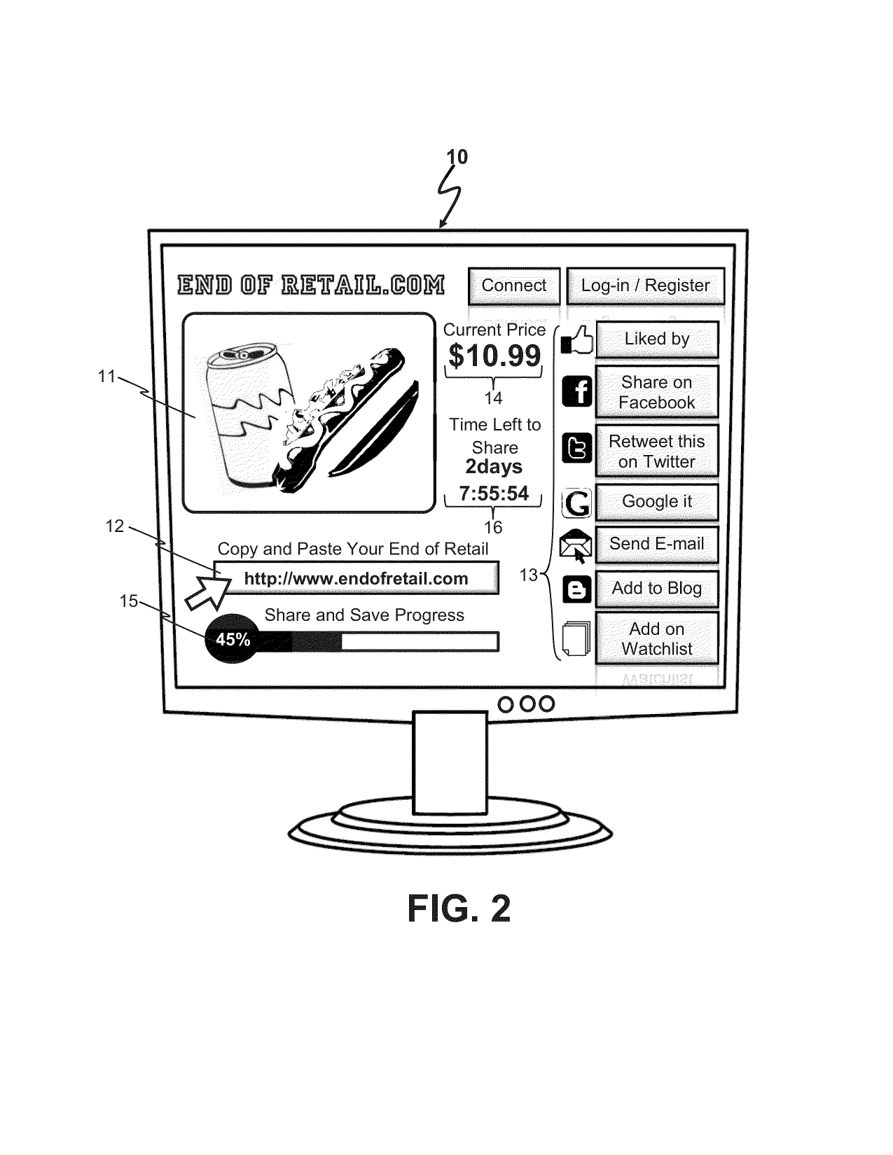

Referring to FIGS. 1-3, there are disclosed a high-level architectural drawing illustrating the primary components of a system and method 100 that operates in accordance with the present invention, a screen display of the vendor's website 10, as well a screen display illustrating an exemplary portal of a social website 30.

The present invention provides a system and method 100, implemented in part on a vendor's 10 website for enabling customers 20 to control the price of a given product 11 by sharing the product and making referrals via their social networking systems. This social networking system may include friends who are members of social websites 30 and/or friends who do not belong to any social website. In other words, the price of a given product 11 is driven down by popularity. That means, the more an item is shared and talked about the lower the price. Hence, the system may be called “social price program” and the final price may be called “social price”. The popularity of a given product 11 may be determined based on the number of referrals. The system and method 100 utilizes a referral counter 40 to count and track the quantity of referrals to control the final price of a given product 11. Each unique referral that comes from customers 20 using the system 100 will be converted to a given integer (referred as “drop point”) by a pricing tool 19 according to a preset formula. The pricing tool 19 then subtracts the drop point 19 from the original price and outputs the new price to display on the price progress bar 15. For example, originally, product X costs 10.99 dollars. The drop point for each unique referral for product X is set to be worth one penny. As a result, once this given product X gets 1,099 unique referrals the final price will then become 0.00 dollars. Alternatively, the system and method may set a bottom limit for the price, for example, 50% discount as the bottom limit. When the price of a give product is reduced to 50% of the original price, the system and method 100 no longer receives referrals; the price is finalized and post on the vendor's website 10.

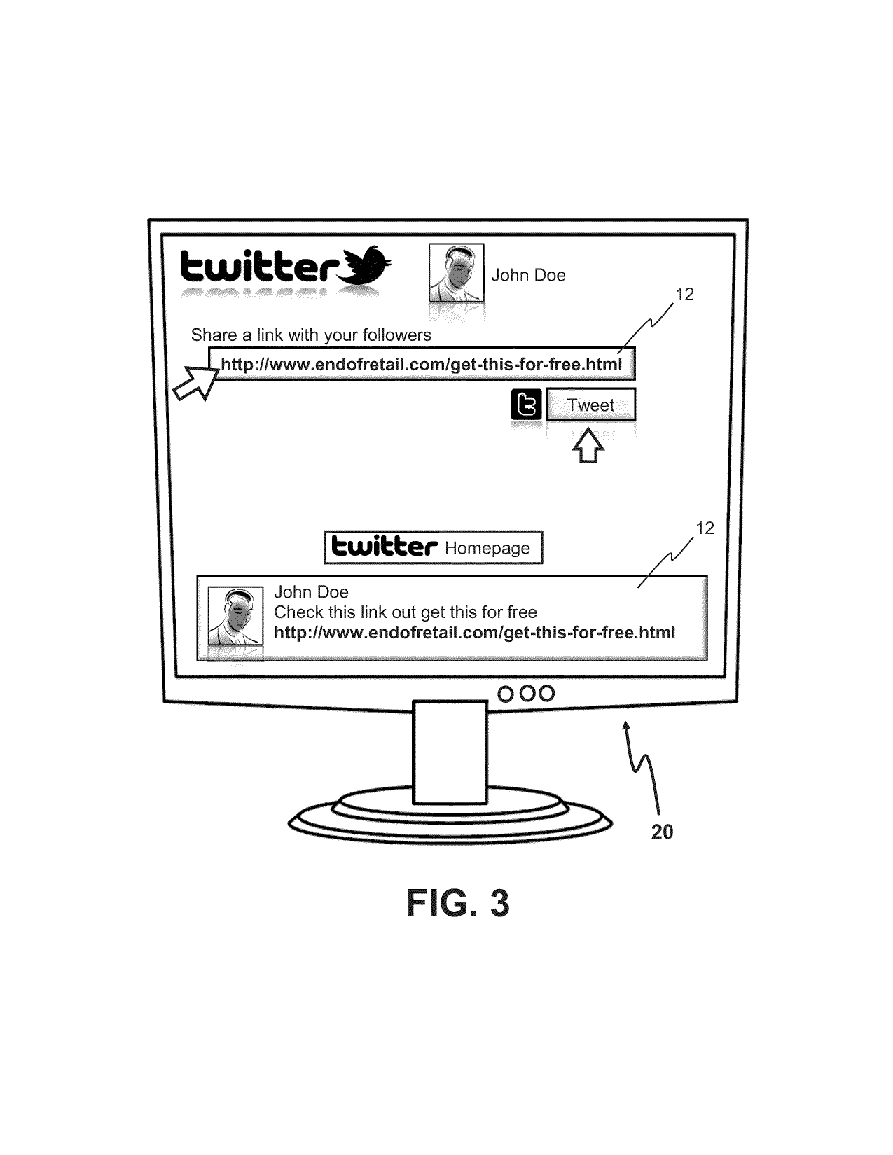

The vendor's website page 10 will provide the product-specific referral link (referred as “product link” hereinafter) 12 that can be copied and pasted, and social tools 13 in a form of smart graphic icon button. Social tools 13 are a conduit to get the referral traffic. The social tools 13 functions as a link, allowing the customer 20 to click on the icon 13 in order to link to the social website 30 or send friends email. Potential customers 20 will be able to connect to the social website 30 by simply clicking the social tools 13. The customer is brought to the social website 30 and the product link 12 is then posted in the customer's social website page 32 after the customer's approval. The portal of the social website 30 will ask the customer whether to post the link 12. Once the customer 20 gives their approval, the product link 12 will be posted on the customer's social website page 32. FIG. 3 is a screen display illustrating the portal asking user's approval to post the product link on their social network and an example of the customer's social website page showing link has been posted on Tweeter. This product link 12 includes the unique ID of the given product 11 so once clicked, will allow customer's friends to link to the vendor's website 10 to view the given product 11. If one of the customer's friend clicks on the product link 12 on the customer's social website page 32 and is brought to the vendor's website 10, it will be considered as one referral by the referral counter 40. The price of the given product 11 will then be driven down by one “drop point” which may be one penny or more.

The customers may also send product link 12 to friends who do not belong to any social websites by copying and pasting the product link 12 in emails. Their friends can simply click product link 12 and be brought back to the vendor website 10.

The website also has a timer 16 counting down the time against a preset time period for the customers to share with friends and make referrals. The referrals have to be made within the time period to effectuate the price change. The time period can be ended sooner if the preset target price is reached before the preset time period is up.

The changing price will be reflected on the price progress bar 15 while the current price 14 on the website 10 will not be changed until the timer 16 is up or the price has reached the preset bottom limit as discussed earlier. Then the final price will be displayed on the website 10 for sell for a period of time.

The system and method 100 can determine how many people visited by setting a cookie with a unique ID for each visitor and save the unique ID in the website's database 17. By retrieving the cookie from the visitor's computer with the web server and then comparing the cookie against information stored in the website's database 17, the system and method 100 can further determine how many visitors are new versus repeat visitors and how often a visitor has visited. The system and method 100 may use other methodologies to identify visitors.

The system and method 100 may have predetermined criteria when considering a referral. A referral may need to be a new visitor or may be a repeated visitor as long as the repeat visit meets the definition of a referral visit; for example, a repeat visit is made after certain time has passed.

In an embodiment, the user will be allowed to change the price only once within a given time period no matter how many visits are made but will be allowed to change the price once again after that time period has passed. For example, a given time period may be set to 24 hours, the user can only change price once within the first 24 hours but can come back to change the price once again within the second 24 hours. This predetermined criteria for considering “referral count” allows the user to check back each day to drop the price. This time period may be adjusted to other time frames such as multiple days or hours.

Alternatively, one referral may be considered as when a customer 20 clicks on the social tools 13 and logs in the social website 30 to post the product link 11. The system and method 100 may utilize other methodologies to count and/or monitor referrals.

The system and method 100 has a price database 18 which stores the price of the given product. The system and method 100 also has a pricing tool 19 to calculate the “drop point” per referral according to the preset formula for each given product. Then the pricing tool 19 subtracts the “drop point” from the original price (shown as “current price” 14 on website 10) and outputs the new price. The new price is then displayed on the website, perhaps, in the graphical form of a price bar 15. Different price formulas may be assigned to different products for each referral.

As mentioned earlier, the website 10 provides the timer 16 indicating how much time left to change the price of the given product and the price bar 15 indicating the price dropping progress, the customers can check the site anytime to see how the progress is being made on the social pricing. Once it is free or it reaches a predetermined bottom limit or timer 16 is up, it will become the daily deal for a period of time, preferably for 7 days. The website also sends newsletter to registered customers as a reminder.

The system and method 100 may or may not require the customers to register on the website 10 for them to benefit from the social price.

In one embodiment, the price reduction is a group effort. It means that the price reduction is the outcome of the total number of referrals that the website 10 receives. In this scenario, the system and method 100 may not require customers to register on the vendor's website for benefiting from the social price (final reduced price). The daily deal of the given product with discount for a period of time may apply to all prospective customers who have or have not made contribution to the price reduction. In other words, all prospective customers can benefit from the social price program and purchase the given product at social price (discounted price) or for free.

In another embodiment, the price reduction may be designed as an individual's effort. The price reduction is based on the total referrals that system can identify the customer is the source of the referral. In this scenario, the system and method 100 may require the prospective customers to enroll on the vendor's website in order to benefit from the final reduced price of a given product no matter whether the registered customers made or did not make referrals. In another embodiment, the system and method 100 may require only registered customers who made referrals can benefit from the final reduced price of a given product. In this case, the product link 12 allowing customers' friends to link to the vendor's web site to view the given product 11 when they click on the product link 12 may include the unique ID of the given product 11 and the ID of the registered customer whose ID was given when enrolled so that the system can memorize who made referrals when the product link 12 is clicked by customer's friends. (The system 100 can use this information to identify the customer who is the source of the referral and to allow for purchase of the reduced price item or the free gift).

Following the referral event, the customer can browse the vendor 10 website for additional products. The referred customer can also choose to click the social tools 13 to post the product link 12 on their own social website pages.

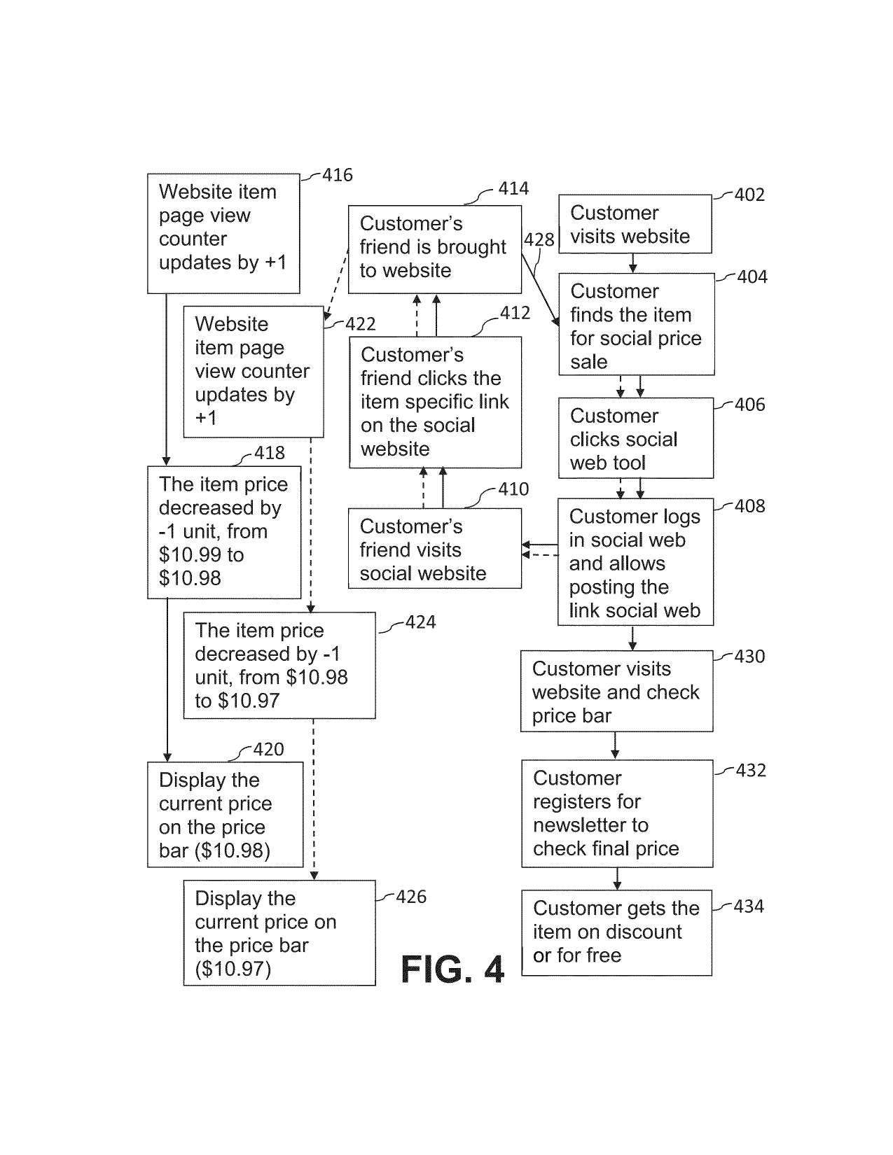

The sequence of events that takes place when the customer clicks on the social tools 13 and start to make referral using product link 12 to effect the price reduction will now be illustrated using a flow diagram 300 shown in FIG. 4. At step 402 and 404, a potential customer 20 visits the vendor's website 10 and finds out a given product is on social price sale. The customer clicks the social tools 13 and logs in the social website 30 to share the product link 12 on his social website page 32 at steps 406 and 408. One of the customer's friends clicks the product link 12 and is brought to the web site 10 (steps 410 to 414). This action triggers the referral counter 40 of the system 100 to update by plus one at step 416. The product price is then dropped by one “drop point”; in this example, the price is dropped by one penny from $10.99 to $10.98 (step 418). The website 10 displays the changing price on the price progress bar 15 ($10.98). If another friend of the customer visits customer's social website page 32 and clicks on the product link 12, the second friend will be brought to the vendor's website 10 and is considered as a second referral, the price will be dropped again by one penny from $10.98 to $10.97 at steps 422-426. If the customer has a lot of friends in his/her social network, the price can quickly reach the preset target price. Furthermore, if any of the customer's friends also click the social tool 13 and post the product link 12 on their social website pages (step 428) their friends can be referred to the product link 12 on the social price website 10 and can also make contribution to the price dropping. Through the expanded networking systems, the price can drop much faster. The customer can check price bar 15 on the website 10, registers for newsletters, and gets free gift or discounted product after the price dropping process has been completed by either the price reaching the preset target or the preset time frame for price change is up (at 430 to 436).

While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for enabling customer to control the price of a given product comprising:
a vendor website allowing customers to access;
a referral system allowing customers to make referral; and
a price system wherein each unique referral that comes from customers using the system will lower the price by a given drop point.

2. The system for enabling customer to control the price of a given product according to claim 1, wherein the referral system comprises social tools that can link a customer to social websites or send friends email by a simple click; a product specific referral link that can link a customer's friend in social networks to the vendor website as a visitor; a referral counter which tracks referrals of visitors to the website; and a database which stores visitors' information.

3. The system for enabling customer to control the price of a given product according to claim 2, wherein the price system comprises a database to store product prices; a pricing tool to convert each unique referral to a drop point according to a preset formula for each given product and subtract the drop point from the original price, and outputs the new price for display; and a price progress bar for displaying price dropping progress.

4. The system for enabling customer to control the price of a given product according to claim 1 further comprises a timing system wherein a timer is set to counting down against a preset time period for customers to share the product and make referrals within the time period in order to effect the price change.

5. The system for enabling customer to control the price of a given product according to claim 1 further comprises a registration system which creates an account for a customer in response to a submission to the registration system by the customer, assigns an identifier to the customer, and stores the customer's information in a database.

6. The system for enabling customer to control the price of a given product according to claim 1 further comprises a transaction system for customers to electronically purchase the products.

7. The system for enabling customer to control the price of a given product according to claim 2, wherein the system utilizes cookie technologies to identify visitors.

8. The system for enabling customer to control the price of a given product according to claim 7 wherein the system can determine how many visitors are new versus repeat visitors and how often a visitor has visited by retrieving the cookie from the visitor's computer with the web server and then comparing the cookie against information stored in the system's database.

9. The system for enabling customer to control the price of a given product according to claim 1 may or may not require the customers to register on the website for them to benefit from the system.

10. The system for enabling customer to control the price of a given product according to claim 1, wherein the product specific referral link may or may not include the information of the customer who makes the referral.

11. A method of enabling customer to control the price of a given product comprising:
providing a vendor website allowing customers to access;
providing a timer capable of counting down against a preset time period within which customers can make product referrals to effect price change;
providing a given product referral link;
providing social tools to link customers to social website or email so that the given product referral link can be posted in customer's social website page or emails to share with their friends who then will be bring to the vendor website once they click the product referral link;
identifying and storing information of each referred visitor in database;
tracking, and counting the referral number;
converting each unique referral that comes from customers using the system to a drop point according to a preset formula for each given product and subtracting the drop point from the original price, and outputting the new price for display;
displaying price dropping progress.

12. The method of enabling customer to control the price of a given product according to claim 11 further comprises creating an account for a customer in response to a registration submitted by the customer, assigning an identifier to the customer, and storing the customer's information in a database.

13. The method of enabling customer to control the price of a given product according to claim 11 further comprises providing a transaction system for customers to electronically purchase the products.

14. The method of enabling customer to control the price of a given product according to claim 11, wherein the method utilizing cookie technologies to identify the referred visitors.

15. The method of enabling customer to control the price of a given product according to claim 11 wherein the method comprises retrieving the cookie from the visitor's computer with the web server and then comparing the cookie against information stored in the database.

16. A method of enabling customer to control the price of a given product comprising:
providing a vendor website that has a given product for social price sale and provides customers access to the website;
providing a system that provides tools for users to refer friends to join in the social price experience in exchange for price discount;
providing social website links and email links that brings users to social websites or emails;
providing product specific referral link that can be copied and pasted and link customer's friend to the vendor website;
providing a system that is capable of counting number of referrals using the given page link to the given product item;
providing a system that is capable of monitoring the referral number and converting that number to drop point and subtracting the drop point from the original price and displaying the subtracted price;
providing a timing system that is capable of timing against a preset time period within which the customer can make effective referrals to change price; and
providing a progress bar it can show how the price is being affected.

17. The system enabling customer to control the price of a given product according to claim 2, wherein the customer's friends in social networks include friends who are members of social website and friends who do not belong to social website.
